(19) United States
(12) Patent Application Publication
(10) Pub. No.: US 2024/0241971 A1
(43) Pub. Date: Jul. 18, 2024

(54) TRANSFORMING A HIERARCHICAL PERMISSIONS MODEL TO A LINEAR PERMISSIONS MODEL USING A CATEGORY APPROACH

(71) Applicant: VMWARE, INC., Palo Alto, CA (US)

(72) Inventors: SREETAM PARIDA, Bangalore (IN); PRAVEEN TIRUMANYAM, Bangalore (IN); NARASIMHA GOPAL GORTHI, Bangalore (IN); NARASIMHA MURTHI, Bangalore (IN); AVINASH VENKATESH BHAT, Bangalore (IN)

(21) Appl. No.: 18/127,682

(22) Filed: Mar. 29, 2023

(30) Foreign Application Priority Data
Jan. 18, 2023 (IN) 202341003567

(51) Int. Cl. G06F 21/60

(52) U.S. Cl. CPC G06F 21/604; G06F 2221/2113; G06F 2221/2141

(57) ABSTRACT

Certain embodiments described herein are generally directed to techniques for determining items of inventory of a data center to which a user has access. Embodiments include receiving permission information indicating specific user permissions assigned to particular items of a plurality of items in an inventory of data center resources, wherein items of the plurality of items are organized in a hierarchical manner across nodes of a hierarchical tree. Embodiments include assigning categories to the plurality of items based on the permission information, wherein each of the particular items is assigned a unique category based on the specific user permissions and each of the plurality of items that is not in the particular items and that has a parent node in the hierarchical tree is assigned a category corresponding to the parent node. Embodiments include storing category information in a data store based on the assigning of the categories.

### RELATED APPLICATIONS

Benefit is claimed under 35 U.S.C. 119(a)-(d) to Foreign Application Serial No. 202341003567 filed in India entitled “TRANSFORMING A HIERARCHICAL PERMISSIONS MODEL TO A LINEAR PERMISSIONS MODEL USING A CATEGORY APPROACH”, on Jan. 18, 2023, by VMware, Inc., which is herein incorporated in its entirety by reference for all purposes.

### BACKGROUND

Software defined networking (SDN) comprises a plurality of hosts in communication over a physical network infrastructure, each host having one or more virtualized endpoints such as VMs, containers, or other virtual computing instances (VCIs) that are connected to logical overlay networks that may span multiple hosts and are decoupled from the underlying physical network infrastructure. Though certain aspects are discussed herein with respect to VMs, it should be noted that they may similarly be applicable to other suitable VCIs. Furthermore, certain aspects discussed herein may similarly be applicable to physical machines. Some embodiments of the present disclosure may also be applicable to environments including both physical and virtual machines.

In a software-defined data center (SDDC), virtual infrastructure, which includes VCIs and virtualized storage and networking resources, is provisioned from hardware infrastructure that includes a plurality of hosts, storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, managing the full inventory of a customer from single pane of glass across all of the SDDCs of the customer has proven to be challenging. To be able to do so, the customer should be able view items in the inventory across all of the SDDCs, but rights to view the items in the inventory is governed by role-based access control and typically require computation of hierarchical permissions across a large number of inventory items. When large numbers of inventory items are involved, permissions determinations can be challenging and computationally expensive.

Accordingly, there is a need in the art for improved techniques of cloud-based inventory management for SDDCs.

### BRIEF DESCRIPTION OF THE DRAWINGS

FIG. 1 is a block diagram of a computing environment in which embodiments of the present disclosure may be implemented.

FIG. 2 is a block diagram of a process related to determining items of inventory of a data center to which a user has access.

FIG. 3 is another block diagram of a process related to determining items of inventory of a data center to which a user has access.

FIG. 4 illustrates an example hierarchical tree related to a category-based approach for determining items of inventory of a data center to which a user has access.

FIG. 5 illustrates example operations related to determining items of inventory of a data center to which a user has access.

### DETAILED DESCRIPTION

One or more embodiments provide a cloud platform from which various services, referred to herein as “cloud services” are delivered to one or more SDDCs through agents of the cloud services that are running in an appliance (referred to herein as a “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the respective agents of the cloud services.

The cloud platform according to one or more embodiments also includes an authorization service that is responsible for computing the effective permissions of a logged-in user across all SDDCs of the customer by identifying the items in the inventory hierarchy to which the user has access or should be denied access. When the user requests a list of certain items in the inventory, e.g., virtual machines, across all SDDCs, or events relating to such items, the inventory service or the events service identifies the requested items of inventory or events to which the user has access or should be denied access.

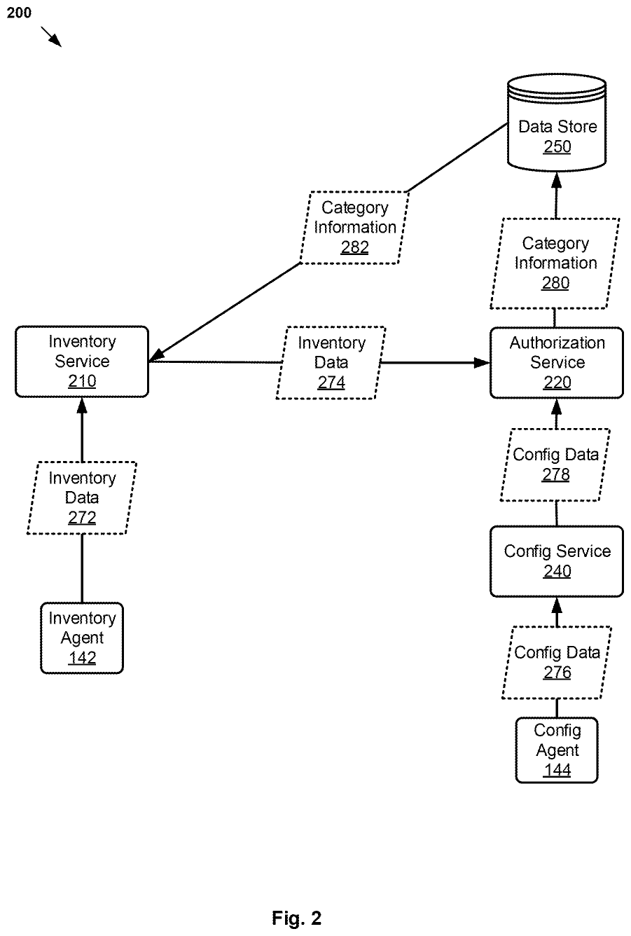

Embodiments of the present disclosure provide improved techniques for determining items of inventory to which a user has access, involving the use of a category-based approach. One technique for managing permissions for data center inventory items is described in co-pending U.S. patent application Ser. No. 17/901,903, entitled “SYSTEM AND METHOD FOR GENERATING ITEMS OF INVENTORY A USER CAN ACCESS BASED ON HIERARCHICAL PERMISSIONS,” the contents of which are incorporated herein by reference in their entirety. While certain techniques may involve determining the items of inventory to which a user has access based on inventory paths in a hierarchical tree, these techniques may be inefficient and result in high amounts of computing resource utilization in certain cases, particularly for large inventories. For example, storing and publishing the inventory path for each item to which a user has been granted access and then interpreting such paths by a consuming service may be a challenging process and may involve a significant amount of processing and complexity. Furthermore, there may be multiple paths to a given item in an inventory hierarchy, such as based on hierarchical representations of different views of the inventory (e.g., user view and folder view), and storing/publishing/interpreting/traversing multiple paths for each item to which a given user has access may increase the inefficiencies and complexities of path-based permission determination techniques. Such path-based techniques generally require the use of “LIKE” based queries to retrieve items using paths, and these queries are resource-intensive and time consuming operations. Thus, as described in more detail below with respect to FIGS. 2-5, embodiments of the present disclosure involve assigning categories to inventory items based on assigned permissions, with child nodes in the hierarchy inheriting categories from parent nodes unless the child nodes have been explicitly assigned different permissions than their parent nodes. Thus, when a user requests to view the inventory items to which the user has access, embodiments of the present disclosure allow the items to be efficiently identified based on categories without requiring multiple traversals of the hierarchical tree.

Techniques described herein provide multiple technical improvements with respect to existing techniques for cloud-based data center management. For example, embodiments of the present disclosure improve security by utilizing permission information to limit the items from an inventory that are displayed in a cloud-based data center management component for a particular user to only the items to which that user has been granted access. Furthermore, techniques described herein reduce computing resource utilization, reduce latency, and thereby improve the functioning of the computing devices involved through the use of a category-based approach for determining items of an inventory to which a user has access rather than the use of a path-based approach. For example, the number of specifically-assigned permissions is generally much lower than the number of inventory items, so assigning unique categories (e.g., other than a default category) only to items with specifically-assigned permissions and having child nodes inherit the categories of parent nodes unless the child nodes have been specifically assigned permissions reduces the amount of data that needs to be stored, communicated, interpreted, and/or otherwise processed in order to determine the inventory items that a user is authorized to access. Additionally, embodiments of the present disclosure provide an extensible framework for permission evaluation that can easily be adopted in a cloud computing environment independent of one or more data centers that are managed through a cloud-based data center management component. Certain embodiments decouple the permission administration (e.g., at a management plane of a data center) and the permission evaluation (e.g., implemented via one or more cloud services), allowing these aspects of the process to be configured and scaled independently of one another. Techniques described herein simplify the adoption and integration of an authorization service with other cloud services such as a cloud-based data center management component, improve efficiency, reduce latency, and support new use cases with minimal changes required to consuming services (e.g., by providing functionality that can be easily integrated with different types of services).

Furthermore, unlike path-based approaches, the category-based techniques described herein do not always require an update at a consuming service when inventory items are moved in the hierarchical tree because categories of items with explicit permissions defined (and their respective children in the hierarchy) will not be affected upon item movement, thereby further improving efficiency.

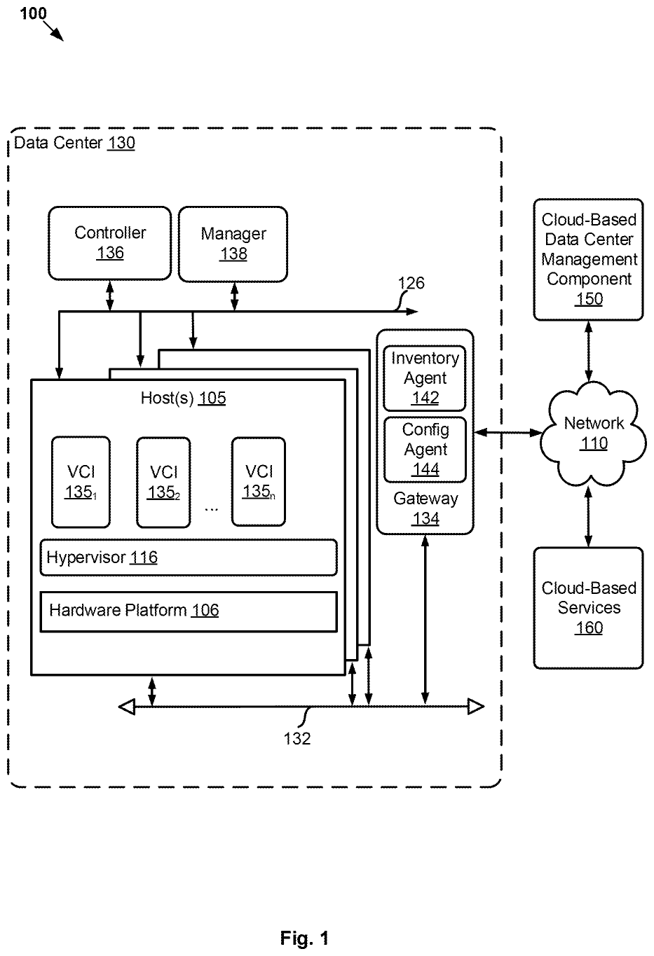

FIG. 1 depicts an example computing environment 100 comprising physical and virtual network components with which embodiments of the present disclosure may be implemented.

Computing environment 100 includes data center 130 connected to network 110. Network 110 is generally representative of a network of computing entities such as a local area network (“LAN”) or a wide area network (“WAN”), a network of networks, such as the Internet, or any connection over which data may be transmitted.

Data center 130 generally represents a set of networked computing entities, and may comprise a logical overlay network. Data center 130 includes host(s) 105, a gateway 134, a data network 132, which may be a Layer 3 network, and a management network 126. Data network 132 and management network 126 may be separate physical networks or different virtual local area networks (VLANs) on the same physical network.

Each of hosts 105 may be constructed on a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 into multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like.

Hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine. Although aspects of the disclosure are described with reference to VMs, the teachings herein also apply to other types of virtual computing instances (VCIs) or data compute nodes (DCNs), such as containers, which may be referred to as Docker containers, isolated user space instances, namespace containers, etc. In certain embodiments, VCIs 135 may be replaced with containers that run on host 105 without the use of a hypervisor.

Gateway 134 provides VCIs 135 and other components in data center 130 with connectivity to network 110, and is used to communicate with destinations external to data center 130 (not shown). Gateway 134 may be a virtual computing instance, a physical device, or a software module running within host 105. Gateway 134 includes an inventory agent 142 and a configuration agent 144. For example, inventory agent 142 may be an agent of an inventory service running outside of data center 130 (e.g., one of cloud-based services 160) that gathers inventory information (e.g., from manager 138) and provides the inventory information to the inventory service. Similarly, configuration agent 144 may be an agent of a configuration service running outside of data center 130 (e.g., one of cloud-based services 160) that gathers configuration information (e.g., from manager 138), such as permission information, and provides the configuration information to the configuration service.

Controller 136 generally represents a control plane (e.g., “central control plane” for data center 130) that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs, containers, logical switches, logical ports, logical routers, and/or the like) and the connections between the endpoints, as well as rules governing communications between various endpoints and user permissions with respect to endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user.

Cloud-based data center management component 150 generally represents a software application for viewing and managing data center inventory items, and may be located on one or more cloud servers separate from one or more data centers that are managed. For example, cloud-based data center management component 150 may include a user interface and/or an application programming interface (API) by which a user can request to view certain items in the inventory, e.g., virtual machines, across one or more SDDCs, and/or events relating to such items. Techniques described herein may be used to determine which inventory items a requesting user is authorized to access, such as based on communications between cloud-based data center management component 150 and one or more cloud-based services 160.

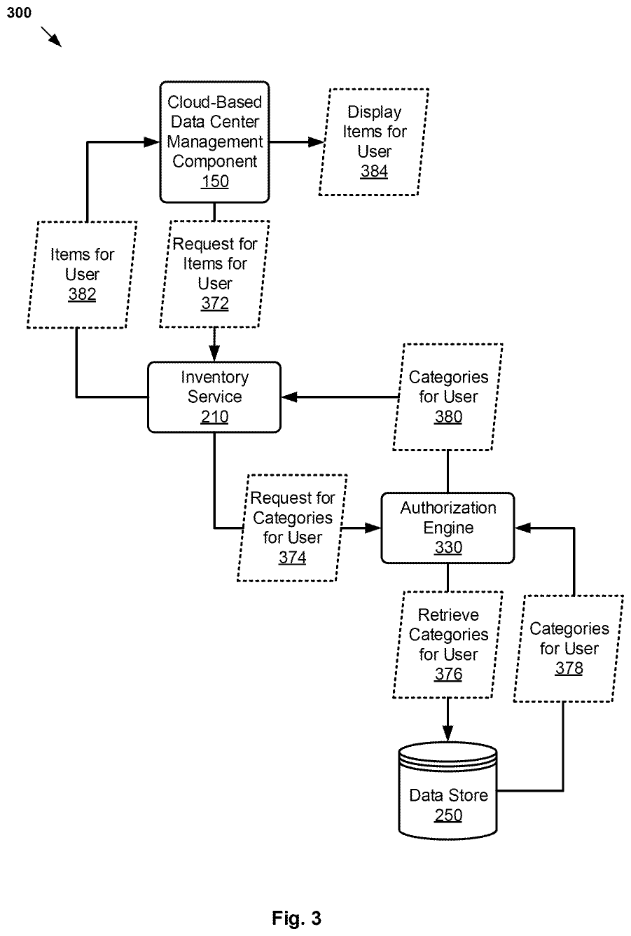

Cloud-based services 160 generally include one or more services running on one or more cloud servers that provide particular functionality related to determining which inventory items a requesting user is authorized to access. Cloud-based services 160 may run on the same or different cloud server(s) than cloud-based data center management component 150. In one example, cloud-based services 160 include an inventory service, a configuration service, an authorization service, an authorization engine, and/or the like, as described in more detail below with respect to FIGS. 2 and 3.

FIG. 2 is a block diagram 200 of a process related to determining items of inventory of a data center to which a user has access. Block diagram 200 includes inventory agent 142 and configuration agent 144 of FIG. 1. Block diagram 200 also includes inventory service 210, configuration service 240, and authorization service 220, which may be examples of cloud-based services 160 of FIG. 1.

Inventory agent 142 (e.g., located on a gateway of a data center such as data center 130 of FIG. 1) provides inventory data 272 to inventory service 210. For example, inventory agent 142 may obtain information about items in an inventory from a management plane of a data center, such as from manager 138 of FIG. 1, and provide the information to inventory service 210. In some cases there may be a respective inventory agent on each of a plurality of data centers, and each inventory agent may similarly provide inventory data to inventory service 210. In some cases, inventory agent 142 receives inventory data on an ongoing basis as changes occur to the inventory and associated permissions, and provides updated inventory data to inventory service 210 on an ongoing basis, such as at regular intervals or as updates occur. Inventory data 272 may include, for example, information that identifies items in an inventory of one or more data centers and identifies hierarchical relationships among the items, such as in the form of a hierarchical tree, as well as inventory permissions, such as assigning users permissions to access particular inventory items. The items may include, for example, groups (e.g., logical abstractions that include multiple items), data centers, hosts, VCIs, resource groups, and/or the like. A parent-child relationship between two items in the hierarchical tree generally indicates that the child is a member of or otherwise depends upon the parent. For example, a VM that is a child of a particular host in the hierarchical tree may be a VM that runs on that particular host. Inventory service 210 provides inventory data 274 (which may be the same as inventory data 272) to authorization service 220.

Configuration agent 144 (e.g., located on a gateway of a data center such as data center 130 of FIG. 1) provides configuration data 276 to configuration service 240. For example, configuration agent 144 may obtain information about user roles, security groups, and/or the like from a management plane of a data center, such as manager 138 of FIG. 1, and provide the information to configuration service 240. In some cases there may be a respective configuration agent on each of a plurality of data centers, and each configuration agent may similarly provide configuration data to configuration service 240. In some cases, configuration agent 144 receives configuration data on an ongoing basis as changes occur to the configuration data (e.g., based on inputs by an administrator to the management plane), and provides updated configuration data to configuration service 240 on an ongoing basis, such as at regular intervals or as updates occur. Configuration data 276 may include, for example, indications of roles assigned to users, user groups and the users that are members of such groups, and/or the like. Configuration service 240 provides configuration data 278, which may be the same as configuration data 276, to authorization service 220.

Authorization service 220 generally acts as a store for all authorization-related data, such as permissions, roles, privileges, and the like, that are used to enforce permissions on the inventory items. These types of authorization-related data are collected from inventory service 210 and configuration service 240. In one example, authorization service 220 is a “headless” service with no API endpoints, and primarily consumes updates from inventory service 210 and configuration service 240. Alternatively, authorization service 220 publishes one or more APIs to manage roles and assignment of roles.

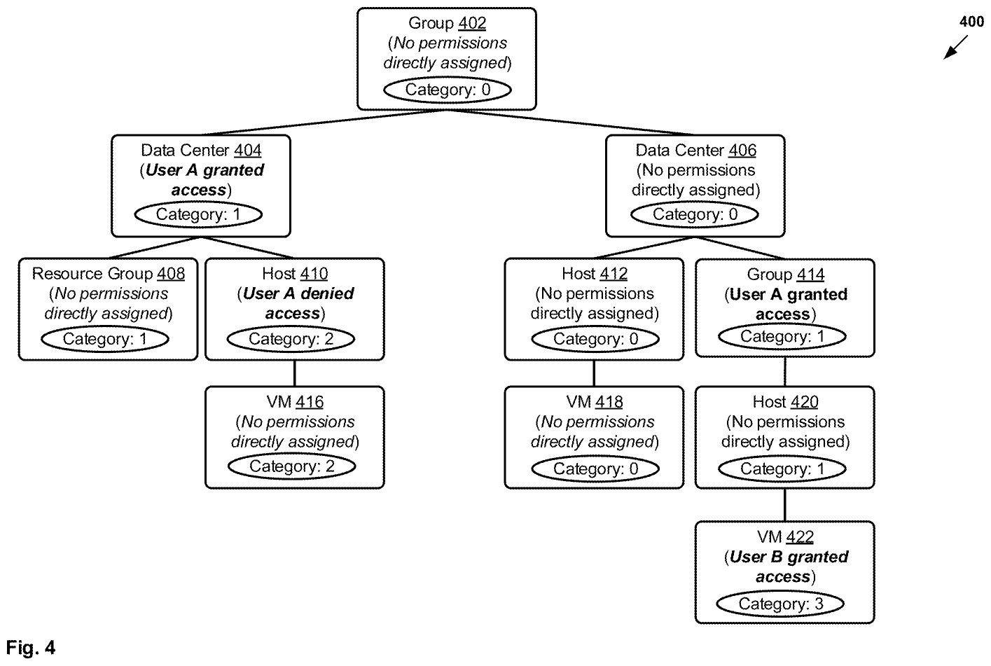

Authorization service 220 receives inventory data 274 and configuration data 278, and assigns categories to items in inventory data 274 based on the hierarchical relationships among the items and any permissions assigned to the items. For example, as described in more detail below with respect to FIG. 4, authorization service 220 may have each child node in the hierarchy “inherit” the category assigned to its parent node unless the child node is assigned explicit permissions in inventory data 274. For instance, a root node of the hierarchy may be assigned a “default” category (unless the root node has been assigned explicit permissions), unique categories may be assigned to all items that have explicit permissions assigned in inventory data 274, such as based on the permissions that are assigned (e.g., all nodes that are assigned the same permission set may be assigned the same category), and then each child node that has not been assigned a category may be assigned the category of its parent node.

Authorization service 220 provides category information 280 to a data store 250, which stores the category information 280 for use in determining which items a given user is authorized to access. In some embodiments, category information 280 includes associations between categories and users and/or user groups. For instance, if all items for which users A and B were granted access were assigned category 1, then category information 280 may indicate an association between category 1 and users A and B. If all items for which user B was granted access were assigned category 2, then category information 280 may indicate an association between category 2 and user B. In certain embodiments, category information 280 also includes associations between categories and inventory items. For example, category information 280 may indicate an association between category 1 and each item that is assigned category 1 by authorization service 220.

Inventory service 210 receives category information 282 (which may be the same as category information 280) from data store 250, such as for use in resolving categories to particular inventory items.

Data store 250 may for example, comprise a cache. In one embodiment, data store 250 is a distributed, in-memory key-value database, cache and message broker, such as a Redis® cluster.

FIG. 3 is another block diagram 300 of a process related to determining items of inventory of a data center to which a user has access. Diagram 300 includes cloud-based data center management component 150, inventory service 210, and data store 250 of FIG. 2. Block diagram 300 also includes an authorization engine 330, which performs operations related to determining which categories a given user is authorized to access.

Authorization engine 330 may for example, evaluate the accessibility of categories based on permissions and user requests. Evaluated categories may then be returned by authorization engine 330 as a response to such a request from a consuming service. Communication between authorization engine 330 and authorization service 210 of FIG. 2 (e.g., via data store 250) may be abstracted from the consuming services.

In an example, the process depicted in block diagram 300 may occur after the process depicted in block diagram 200 of FIG. 2.

At block 372, cloud-based data center management component 150 sends a request for items for a user to inventory service 210. For example, the user may have requested to view all items to which the user has access via a user interface associated with cloud-based data center management component 150. Inventory service 210 send authorization engine 330 s a request for categories to which the user has access at block 374.

At block 376, authorization engine 330 retrieves the categories to which the user has access from data store 250, receiving the categories for the user at block 278. The categories for the user generally represent all categories associated with the user. For example, if category 1 represents a permission set including user A and user B and category 2 represents a permission set including user B and user C, then user B would be associated with both category 1 and category 2. Categories are generally stored as a single column and, unlike a path-based approach, there is no need to perform queries on multiple columns (e.g., primary and alternate paths).

At block 380, authorization engine 330 provides the categories for the user to inventory service 210, such as in response to the request sent at block 374. Inventory service 210 may then resolve the categories to inventory items (e.g., determine which inventory items are in the categories), such as based on the category information 282 of FIG. 2 that was received by inventory service 210 from data store 250 in the process previously depicted in block diagram 200 of FIG. 2. Inventory service 210 then returns the items for the user to cloud-based data center management component 150 at block 382, such as in response to the request sent at block 372. Thus, embodiments of the present disclosure allow for querying only the inventory items associated with the categories that the user is authorized to access, thereby simplifying the querying and filtering.

At block 384, cloud-based data center management component 150 displays the items received at block 382 to the user, such as via a user interface. For example, the user interface may allow the user to view and otherwise manage the items that the user is authorized to access in the one or more data centers that are managed by cloud-based data center management component 150.

In some embodiments, inventory service 210 is implemented as a sidecar service of cloud-based data center management component 150. For example, a service may be implemented in the form of a pod that includes multiple containers, including a main container and one or more sidecar containers, which are responsible for supporting the main container. A container may include, for example, cloud-based data management component 150 as a main container and inventory service 210 as a sidecar container that supports the main container by providing inventory-related functionality, such as determining the inventory items that a user is authorized to access, as described herein. This pod implementation is included as an example, and other implementations are possible. Separating inventory service 210 from cloud-based data center management component 150 as an independent component, as well as separating inventory service 210 from authorization engine 330, and data store 250, as well as from authorization service 220 and configuration service 240 of FIG. 2, allows the functionality of inventory service 210 to be easily added to a cloud computing environment. For example, inventory service 210 may be added as a sidecar service or otherwise to support any number of cloud-based services that perform functionality related to data center inventories, such as exposing an API to such services for efficient integration.

FIG. 4 illustrates an example hierarchical tree 400 related to a category-based approach for determining items of inventory of a data center to which a user has access.

Hierarchical tree 400 may represent a hierarchical arrangement of items in the inventories of one or more data centers, such as including data center 130 of FIG. 1.

A group 402 is the root node of the tree. For example group 402 may be a group that is configured by an administrator to include two data centers 404 and 406. Data centers 404 and 406 are included as child nodes of group 402 in the tree because they are members of group 402.

A resource group 408 and a host 410 are included as child nodes of data center 404 in the tree, such as because resource group 408 and host 410 are located within data center 404. Resource group 408 may include, for example, a set of compute, networking, and/or storage resources dedicated to tenant workloads. Host 410 may be a host computer such as a host 105 of FIG. 1. A VM 416 is included as a child node of host 410 in the tree, such as because VM 416 runs on host 410.

A host 412 and a group 414 are included as child nodes of data center 406 in the tree because host 412 and group 414 are located in data center 406. A VM 418 is included as a child node of host 412 because VM 418 runs on host 412. A host 420 is included as a child node of group 414 in the tree because host 420 is a member of group 414. Similarly, a VM 422 is included as a child node of host 420 in the tree because VM 422 runs on host 420.

According to embodiments of the present disclosure, the root node of the tree will be assigned a default category (e.g., category 0) unless the root node has been specifically assigned permissions. Child nodes in the tree that are not assigned specific permissions will inherit the category of their parent nodes. All nodes that have been assigned specific permissions will be assigned a unique category, such that all nodes that are specifically assigned the same permission set will be assigned the same category.

A category generally refers to a classification label or marker indicating assigned permissions for an item. Categories may for instance, be implemented in a short universally unique identifier (UUID) format. Each item may be assigned a single category. Even leaf items such as VMs having primary and alternate parents will have a single category assigned to them. Each category targets a group of items that have a similar set of permissions or do not have any explicit permissions assigned. Creating new categories only when explicit permissions have been assigned reduces complexity and limits the maximum number of categories to the number of items that have explicit permissions assigned. Unlike the inventory path based approach, techniques described herein do not require evaluating the entire inventory tree in every case, but only require evaluating the categories assigned to the items, thereby reducing latency and improving performance.

In hierarchical tree 400, no permissions have been directly assigned to group 402, so it is assigned the default category of 0. Data center 404 has been assigned specific permissions, with user A being granted access. As such, data center 404 is assigned a unique category of 1, which will uniquely be associated with the permission set of user A being granted access. Resource group 508 has not been directly assigned permissions, so it inherits the category of its parent node data center 404, being assigned category 1.

Host 410 is specifically assigned permissions indicating that user A is denied access, so it is assigned a unique category of 2, which will uniquely be associated with the permission set of user A being denied access. VM 416 is not directly assigned any permissions, so it will inherit the category of its parent node host 410, being assigned category 2.

Data center 406 has been directly assigned any permissions, so it inherits the category of its parent node group 402, being assigned the default category 0. Host 412 is not directly assigned any permissions, so it will inherit the category of its parent node data center 406, being assigned default category 0. VM 418 is not directly assigned any permissions, so it will inherit the category of its parent node host 412, being assigned default category 0.

Group 414 is specifically assigned permissions indicating that user A is granted access, so it is assigned the unique category of 1, which is uniquely associated with the permission set of user A being granted access. Host 420 is not directly assigned any permissions, so it will inherit the category of its parent node group 414, being assigned category 1. VM 422 is specifically assigned permissions indicating that user B is granted access, so it is assigned the unique category of 3, which is uniquely associated with the permission set of user A and user B both being granted access (e.g., because VM 422 otherwise depends from group 414 to which user A was granted access).

Thus, category 0 is not associated with any users and includes the inventory items group 402, data center 406, host 412, and VM 418. Category 1 is associated with user A being granted access, and includes data center 404, resource group 408, group 414, and host 420. Category 2 is associated with user A being denied access, and includes host 410 and VM 416. Category 3 is associated with user A and user B being granted access, and includes VM 422.

The categories to which user A has access are category 1 and category 3. User B only has access to category 3. Thus, using techniques described herein, user A's list of authorized inventory items would be determined by resolving category 1 and category 3 to the inventory items included in these categories (data center 404, resource group 408, group 414, host 420, and VM 422) and user B′s list of authorized inventory items would be determined by resolving category 3 to the inventory items included in this category (VM 422).

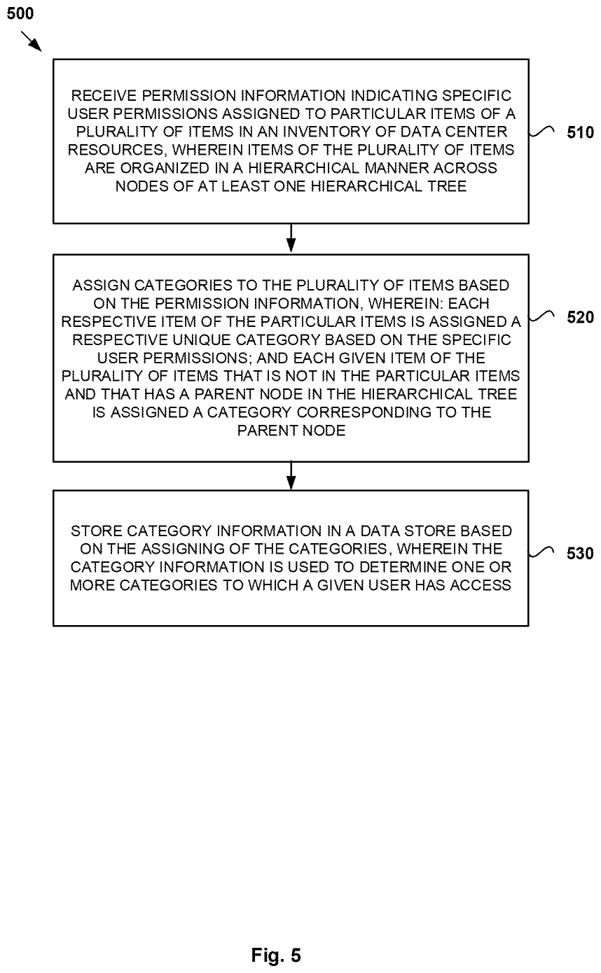

FIG. 5 illustrates example operations 500 related to determining items of inventory of a data center to which a user has access. For example, operations 500 may be performed by cloud-based data center management component 150, one or more cloud-based services 160, inventory agent 142, and/or configuration agent 144 of FIG. 1, and/or one or more other components.

Operations 500 begin at step 510, with receiving permission information indicating specific user permissions assigned to particular items of a plurality of items in an inventory of data center resources, wherein items of the plurality of items are organized in a hierarchical manner across nodes of at least one hierarchical tree.

In some embodiments, the permission information and the at least one hierarchical tree are received from a management component of the data center.

Operations 500 continue at step 520, with assigning categories to the plurality of items based on the permission information, wherein: each respective item of the particular items is assigned a respective unique category based on the specific user permissions; and each given item of the plurality of items that is not in the particular items and that has a parent node in the hierarchical tree is assigned a category corresponding to the parent node.

In certain embodiments, assigning the categories further comprises assigning a default category to one or more items of the plurality of items that are not in the particular items.

Operations 500 continue at step 530, with storing category information in a data store based on the assigning of the categories, wherein the category information is used to determine one or more categories to which a given user has access.

Some embodiments further comprise providing category-to-item mappings to an inventory service based on the assigning of the categories. For example, the inventory service may determine one or more items to which the given user has access based on the category-to-item mappings and the one or more categories to which the given user has access. In certain embodiments, a user-specific inventory view is displayed by a cloud-based data center management component for the given user based on the one or more items to which the given user has access.

In some embodiments, the inventory service is a sidecar service associated with the cloud-based data center management component. For example, the cloud-based data center management component may be implemented as a main container in a pod and the inventory service may be implemented as a sidecar container in the pod.

Certain embodiments as described above involve a hardware abstraction layer on top of a host computer. The hardware abstraction layer allows multiple contexts or virtual computing instances to share the hardware resource. In one embodiment, these virtual computing instances are isolated from each other, each having at least a user application running therein. The hardware abstraction layer thus provides benefits of resource isolation and allocation among the virtual computing instances. In the foregoing embodiments, virtual machines are used as an example for the virtual computing instances and hypervisors as an example for the hardware abstraction layer. As described above, each virtual machine includes a guest operating system in which at least one application runs. It should be noted that these embodiments may also apply to other examples of virtual computing instances, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims. Note that some explanations herein may reflect a common interpretation or abstraction of actual processing mechanisms. Some descriptions may therefore abstract away complexity and explain higher level operations without burdening the reader with unnecessary technical details of well understood mechanisms. Such abstractions in the descriptions herein should be construed as inclusive of the well understood mechanisms.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for determining items of inventory of a data center to which a user has access, the method comprising:
receiving permission information indicating specific user permissions assigned to particular items of a plurality of items in an inventory of data center resources, wherein items of the plurality of items are organized in a hierarchical manner across nodes of at least one hierarchical tree;
assigning categories to the plurality of items based on the permission information, wherein:
each respective item of the particular items is assigned a respective unique category based on the specific user permissions; and
each given item of the plurality of items that is not in the particular items and that has a parent node in the hierarchical tree is assigned a category corresponding to the parent node;
storing category information in a data store based on the assigning of the categories, wherein the category information is used to determine one or more categories to which a given user has access.

2. The method of claim 1, wherein the permission information and the at least one hierarchical tree are received from a management component of the data center.

3. The method of claim 1, wherein assigning the categories further comprises assigning a default category to one or more items of the plurality of items that are not in the particular items.

4. The method of claim 1, further comprising providing category-to-item mappings to an inventory service based on the assigning of the categories.

5. The method of claim 4, wherein the inventory service determines one or more items to which the given user has access based on the category-to-item mappings and the one or more categories to which the given user has access.

6. The method of claim 5, wherein a user-specific inventory view is displayed by a cloud-based data center management component for the given user based on the one or more items to which the given user has access.

7. The method of claim 6, wherein the inventory service is a sidecar service associated with the cloud-based data center management component.

8. A system for determining items of inventory of a data center to which a user has access, comprising:
at least one memory; and
at least one processor coupled to the at least one memory, the at least one processor and the at least one memory configured to:
receive permission information indicating specific user permissions assigned to particular items of a plurality of items in an inventory of data center resources, wherein items of the plurality of items are organized in a hierarchical manner across nodes of at least one hierarchical tree;
assign categories to the plurality of items based on the permission information, wherein:
each respective item of the particular items is assigned a respective unique category based on the specific user permissions; and
each given item of the plurality of items that is not in the particular items and that has a parent node in the hierarchical tree is assigned a category corresponding to the parent node;
store category information in a data store based on the assigning of the categories, wherein the category information is used to determine one or more categories to which a given user has access.

9. The system of claim 8, wherein the permission information and the at least one hierarchical tree are received from a management component of the data center.

10. The system of claim 8, wherein assigning the categories further comprises assigning a default category to one or more items of the plurality of items that are not in the particular items.

11. The system of claim 8, wherein the at least one processor and the at least one memory are further configured to provide category-to-item mappings to an inventory service based on the assigning of the categories.

12. The system of claim 11, wherein the inventory service determines one or more items to which the given user has access based on the category-to-item mappings and the one or more categories to which the given user has access.

13. The system of claim 12, wherein a user-specific inventory view is displayed by a cloud-based data center management component for the given user based on the one or more items to which the given user has access.

14. The system of claim 13, wherein the inventory service is a sidecar service associated with the cloud-based data center management component.

15. A non-transitory computer readable medium storing instructions that, when executed by one or more processors, cause the one or more processors to:
receive permission information indicating specific user permissions assigned to particular items of a plurality of items in an inventory of data center resources, wherein items of the plurality of items are organized in a hierarchical manner across nodes of at least one hierarchical tree;
assign categories to the plurality of items based on the permission information, wherein:
each respective item of the particular items is assigned a respective unique category based on the specific user permissions; and
each given item of the plurality of items that is not in the particular items and that has a parent node in the hierarchical tree is assigned a category corresponding to the parent node;
store category information in a data store based on the assigning of the categories, wherein the category information is used to determine one or more categories to which a given user has access.

16. The non-transitory computer readable medium of claim 15, wherein the permission information and the at least one hierarchical tree are received from a management component of a data center.

17. The non-transitory computer readable medium of claim 15, wherein assigning the categories further comprises assigning a default category to one or more items of the plurality of items that are not in the particular items.

18. The non-transitory computer readable medium of claim 15, wherein the instructions, when executed by the one or more processors, further cause the one or more processors to provide category-to-item mappings to an inventory service based on the assigning of the categories.

19. The non-transitory computer readable medium of claim 18, wherein the inventory service determines one or more items to which the given user has access based on the category-to-item mappings and the one or more categories to which the given user has access.

20. The non-transitory computer readable medium of claim 19, wherein a user-specific inventory view is displayed by a cloud-based data center management component for the given user based on the one or more items to which the given user has access.
